(19) United States
(12) Patent Application Publication
(10) Pub. No.: US 2005/0014886 A1
(43) Pub. Date: Jan. 20, 2005

(54) Pre-crosslinked film forming polymer, release coatings, and methods

(76) Inventors: Michael J. Yanutola, Tega Cay, SC (US); Douglas W. Harper, Columbia, SC (US)

Correspondence Address: Omnova Solutions Inc., 175 Ghent Road, Fairlawn, OH, 44333-3300, US

(21) Appl. No.: 10/623,348

(22) Filed: Jul. 18, 2003

(51) Int. Cl. C08J 3/00

(52) U.S. Cl. 524/503

(57) ABSTRACT

Described are crosslinked film forming polymers, compositions, coatings, and films such as release coatings prepared from the film forming polymers, coated products, and related methods for preparing and using the crosslinked film forming polymers, with preferred embodiments relating to aqueous backsize compositions comprising pre-crosslinked and optionally post-crosslinkable film forming polymer comprising monomeric units derived from monomers comprising multifunctional pre-crosslinking compound containing at least two reactive groups, and monofunctional monomer.

### FIELD OF THE INVENTION

The invention relates to film forming polymers; compositions, coatings and films such as backsize and release coatings prepared from the film forming polymers; coated products; and related methods for preparing and using film forming polymers. Particular uses relate to low adhesion backsize compositions and release coatings that contain film forming polymer, release agent, and thickener, particularly in product constructions useful with pressure-sensitive adhesives.

### BACKGROUND

Pressure sensitive adhesive products, e.g., tapes, labels, etc., commonly use a release coating (or “low adhesion backsize” or “backsize”) to create good handling characteristic such as reversible adhesion or an ability to unwind a roll product. A general discussion of backsize materials is found in the Handbook of Pressure Sensitive Adhesive Technology, 3d Edition 1999 (ISBN 0-9637993-3-9) Chapter 26 “Release Coatings” by D. Satas. A release coating is generally designed to contact a pressure sensitive adhesive surface, and has a chemical makeup that allows the pressure sensitive adhesive (“PSA”) to be reversibly and controllably adhered to and removed from the backsize coated surface without unduly affecting the adhesive. The release coating preferably has good mechanical properties and durability so it does not transfer to the adhesive upon separation from the adhesive.

Backsize materials may generally include a combination of a film forming polymer and a release agent, generally in combination with useful additives such as one or more of a catalyst or one or a combination of surfactants. These ingredients may be incorporated into a backsize composition in different forms, including dry forms, forms suspended or dissolved in organic solvent or water, or as 100 percent solids, neat, or solventless.

Water-based backsize compositions (those that include a substantial portion of water) offer advantages such as reduced odor and reduced flammability. Preferred water-based backsize compositions include aqueous emulsions, dispersions, and suspensions. Useful aqueous backsize compositions should be capable of being produced without undue gelation (e.g., of polymer), and should be able to be coated and dried with practical efficiency. Preferred aqueous backsize compositions can be stable in a suspended, dispersed, or emulsified form, even during transport and storage, meaning, e.g., that the composition does not separate into layers that must be stirred, dispersed, or re-dispersed prior to application of the composition to a substrate or other processing.

The film forming polymer contributes to properties of the aqueous backsize composition during processing and coating, and also contributes to properties of a final dried or dried and cured release coating. The film forming polymer can preferably allow -coating of the low adhesion backsize composition onto a substrate to form a useful low adhesion release surface. This can mean that the dried polymeric film contains release agent that will produce a low adhesion surface for a pressure sensitive adhesive, and that the dried coating is preferably durable and preferably does not transfer to the adhesive. Optionally, certain film forming polymers have included reactive crosslinking groups that allow the polymer to be crosslinked following application to a substrate (i.e., “post-crosslinked” or “cured”).

There is ongoing need for coatable low adhesion backsize compositions useful to produce dried or dried and cured release coatings on substrates, for use with pressure sensitive adhesives. Preferred backsize compositions can include reduced amounts of organic solvent or can be substantially organic solvent-free, and can be processed with relative ease and efficiency to a coated and dried low adhesion surface. Preferred backsize compositions can be stable, to not require continuous agitation or re-dispersion. In addition to having adhesion and transfer properties that will be generally useful with a pressure sensitive adhesive, preferred backsize compositions can additionally produce durable coated films that are relatively solvent-resistant, heat-resistant, or both.

### SUMMARY

The invention relates to film forming polymers and their use in backsize compositions, as well as derivative dried or dried and cured (e.g., post-crosslinked) release coatings, coated products, and pressure sensitive adhesive products. The film forming polymer includes a crosslinked polymeric network structure that is created upon preparation of the film forming polymer, during polymerization, and prior to being applied to a substrate (e.g., the film forming polymer is “pre-crosslinked”). The film forming polymer may optionally also include reactive groups that can be further reacted to further crosslink the pre-crosslinked film forming polymer after coating (e.g., the pre-crosslinked polymer may be “post-crosslinkable” and “post-crosslinked”).

The film forming polymer may be used according to the invention to prepare a low adhesion backsize composition (“LAB”) and dried or dried and cured low adhesion coatings thereof (“release coatings”). The film forming polymer can be used in combination with a release agent to prepare a coatable low adhesion backsize composition such as an aqueous emulsion, dispersion, or suspension, which may be dried and optionally cured to form a release coating. According to this arrangement, a composition containing the pre-crosslinked film forming polymer, release agent, and preferably a thickener, can be coated onto a substrate and dried and optionally cured. Upon drying and optional post-cure, the pre-crosslinked film forming polymer adheres the release agent to the substrate, the combination acting as-a release coating. The pre-crosslinked film forming polymer may optionally be further post-crosslinked to form an even more inter-connected polymeric network.

According to the invention, the film forming polymer is pre-crosslinked, meaning that it includes polymeric material in the form of a polymeric network of inter-connected polymers. This can be achieved, for example, by preparing the film forming polymer from materials that include a combination of mono-functional and multifunctional monomers. The multifunctional monomers include at least two reactive groups that each react with monofunctional monomer in forming a polymeric backbone. When different reactive groups of the same multifunctional monomer become associated with separate polymeric backbones, an inter-connected polymeric network forms.

The use of pre-crosslinked film forming polymer in a backsize composition (especially when used with certain thickeners) can offer advantages over similar backsize compositions that contain pre-crosslinked film forming polymer that is not pre-crosslinked but that is otherwise chemically similar. Advantages may be evident during preparation and processing of a low adhesion backsize composition, during coating or drying of a backsize composition, or with respect to properties of a dried release coating prepared from the backsize composition. For example, a backsize composition that contains pre-crosslinked film forming polymer and thickener may exhibit improved film forming properties during formation of a film coating on a substrate. Also, a film prepared from a backsize composition that contains pre-crosslinked film forming polymer and thickener may exhibit improved drying properties. In one specific embodiment of the invention, an aqueous emulsion that contains pre-crosslinked film forming polymer (and optionally thickener) may dry more quickly or at a lower temperature compared to an otherwise similar aqueous emulsion that contains film forming polymer that is otherwise similar but not pre-crosslinked. A dried and optionally post-cured release coating containing pre-crosslinked and cured film forming polymer may exhibit high resistance to solvation in organic solvents as measured by exposure of a dried and optionally cured film forming polymer to solvent such as toluene. The dried pre-crosslinked film forming polymer can also exhibit improved heat resistance compared to substantially similar non-pre-crosslinked film forming polymer.

A pre-crosslinked film forming polymer can be prepared from monomers including monofunctional monomer that forms backbone segments of the polymer, and multifunctional monomer that includes at least two reactive groups. The multifunctional monomer can produce inter-connecting branching or crosslinking (i'e., “pre-crosslinking”) of the polymeric backbone segments and the formation of a pre-crosslinked polymeric network. Optionally, the pre-crosslinked film forming polymer may also include pendant latent reactive groups that can be reacted (e.g., after coating) to further crosslink or cure the already pre-crosslinked polymer.

The film forming polymer can be combined with other ingredients to form a backsize composition, such as a release agent.

The film forming polymer or a backsize composition thereof may optionally and preferably include thickener, preferably of a type and in an amount that will improve stability of the film forming polymer or backsize composition. Preferred thickeners according to some embodiments of the invention may include polyacrylates (e.g., sodium polyacrylate) and cellulosics (e.g., hydroxyethylcellulose).

The pre-crosslinked film forming polymer can be produced by methods including aqueous polymerization, e.g., wherein monomer-containing particles are suspended, dispersed, or emulsified in a continuous aqueous phase, and polymerized.

As an aspect of certain embodiments of the invention, stable aqueous polymeric emulsions, suspensions, or dispersions can be prepared by sequential polymerization methods (wherein monomer is added to a reaction over a period of time), in combination with adding thickener during polymerization, to achieve stable aqueous film forming polymer compositions and aqueous low adhesion backsize compositions. Preferred such aqueous compositions may be stable for up to or exceeding 7 days, 1 month, or 3 months.

The pre-crosslinked film forming polymer can be included in a low adhesion backsize composition and coated onto a substrate and dried to form a release coating. Certain preferred low adhesion backsize compositions of the invention can be in the form of a water-based or aqueous liquid that contains dispersed, emulsified, or suspended particles, the particles including pre-crosslinked, optionally post-crosslinkable, water-insoluble film forming polymer. Depending on the average size of the particles, the polymeric particle-containing composition may be referred to as an emulsion, a suspension, or a dispersion. The low adhesion backsize composition can also include a release agent such as a fluorinated release agent, a silicone release agent, or a long chain hydrocarbon release agent.

A backsize composition of the invention can optionally and preferably include a thickener that may assist in coating the composition onto a substrate. As noted, in some embodiments of the invention a thickener may be used to assist in polymerization of reactive materials to form stable polymeric compositions that contain pre-crosslinked film forming polymer. The thickener may also provide preferred viscosity, resulting in improved coatability, and preferably improved stability.

The thickener can preferably be a thickener that functions within the pH range of the film forming polymer. For example acid-functional thickener may be used with film forming polymer that tends to produce an acidic emulsion, such as poly(vinyl acetate) polymer or copolymer emulsions, which are most commonly at a pH of from 3.5 to 5.5. Exemplary thickeners that function in an acidic environment include functionalized cellulose materials such as polyoxyethylene functionalized cellulose, as well as polyalkylenes such as polyacrylates, e.g., sodium polyacrylate. Advantageously, the use of thickener in combination with a crosslinked film forming polymer may produce stable low adhesion backsize compositions having rheological properties that allow drying and optionally curing under relatively low temperature conditions and that produce relatively uniform and coherent films substantially free of defects caused by blistering that could otherwise result form exposure to high drying temperature.

Thickener can be added to a pre-crosslinked film forming polymer either during or after polymerization. According to certain preferred embodiments of the invention, thickener can be present during preparation of a film forming polymer, e.g., in an emulsion, during reaction of monomers that form the pre-crosslinked film forming polymer. It has been observed in certain embodiments of the invention that the presence of thickener in an emulsion during formation of a film forming polymer can result in desirable particle size or desirable interaction between the crosslinked film forming polymer and the thickener, preferably resulting in a relatively stable polymeric emulsion, and possibly resulting in one or more of improved coating properties, improved drying properties, and improved properties relating to solvent resistance or heat resistance.

According to certain preferred embodiments of the invention, the use of thickener may also improve efficiency and effectiveness of a release agent used in certain low adhesion backsize compositions. For example, a thickener used in an aqueous backsize composition may allow better control of release properties of a dried release coating. This can mean, for example, less sensitivity of an adhesion property of a dried release coating to the concentration of release agent it contains. Additionally, enhanced release performance may be achieved with certain embodiments of the invention. In direct comparisons, an otherwise similar backsize composition that does not contain thickener may require significantly more release agent to attain a certain release property. Thus, similar release properties may be achieved with the use of thickener while advantageously using relatively lower amounts of release agent.

An aspect of the invention relates to a backsize composition that includes pre-crosslinked film forming polymer derived from materials comprising monofunctional monomer and multifunctional pre-crosslinking monomer containing at least two reactive groups; thickener that improves the stability of the backsize composition; and release agent.

Another aspect of the invention relates to an aqueous backsize composition comprising pre-crosslinked film forming polymer derived from materials comprising monofunctional monomer and multifunctional pre-crosslinking monomer containing at least two reactive groups; thickener selected from the group consisting of a polyacrylate thickener, a cellulosic thickener, and a combination thereof; and release agent.

Yet another aspect of the invention relates to a method of preparing aqueous film forming polymer. The method comprises providing aqueous monomer comprising monofunctional monomer and multifunctional pre-crosslinking monomer containing at least two reactive groups; subjecting a portion of the aqueous monomer to polymerization; adding thickener after polymerization of a portion of monomer; and polymerizing a further portion of monomer following addition of the thickener.

Yet another aspect of the invention relates to a method of forming a release coating. The method includes providing a backsize composition comprising pre-crosslinked film forming polymer comprising monomeric units derived from monomer comprising monofunctional monomer and multifunctional pre-crosslinking monomer containing at least two reactive groups; thickener that improves the stability of the backsize composition; and release agent. The backsize composition is coated onto a substrate to form a backsize film, and the film is dried to form a release coating.

### DETAILED DESCRIPTION

Film forming polymers generally include polymeric materials capable of forming a continuous or semi-continuous film when coated from a liquid onto a substrate. Film forming polymers can be used in low adhesion backsize compositions (or simply “backsize compositions”) where, following coating, a film forming polymer can adhere to a substrate, preferably also causing a release agent of the backsize composition to be adhered to the substrate and allowing the release agent to function to provide a low adhesion surface when in contact with a pressure sensitive adhesive.

According to the invention, film forming polymers used in low adhesion backsize compositions are pre-crosslinked, meaning that the polymer includes a multi-dimensional (e.g., three-dimensional) polymeric network of inter-connected polymeric segments. The pre-crosslinked polymers, and low adhesion backsize compositions that contain the pre-crosslinked polymers, can exhibit useful or improved properties during processing and useful or improved final physical characteristics, e.g., compared to otherwise similar non-pre-crosslinked polymers and backsize compositions that include otherwise similar film forming polymer that is not pre-crosslinked. Functionally speaking, low adhesion backsize compositions according to the invention that include a pre-crosslinked film forming polymer can exhibit useful or improved film forming ability, drying properties, or release properties (when dried), especially when used in the form of an aqueous low adhesion backsize composition that also contains thickener. Alternatively or in addition, the aqueous low adhesion backsize compositions can be dried and optionally crosslinked to a low adhesion film coating that exhibits useful or improved heat and solvent resistance.

The degree of crosslinking of the film forming polymer can be an amount to provide useful or improved properties such as processing properties or end-product properties. The specific degree of crosslinking of any particular film forming polymer may be selected depending on factors such as the type and amount of film forming polymer, the type and amount of thickener, etc. Preferred degrees of crosslinking can be amounts that achieve one or more of the properties described herein, such as one or more of the desired coating or drying properties of the low adhesion backsize composition, adhesion properties, or solvent or heat resistance of a dried release coating. It can be preferred to avoid excessively high degrees of crosslinking, because excessive crosslinking may cause premature or otherwise unwanted gelation or coalescing of the polymer.

As one specific example, embodiments of pre-crosslinked film forming polymer, especially when in the form of a subsequently cured or post-crosslinked polymer, can exhibit relatively high resistance to organic solvent such as toluene. For example, a composition comprising a pre-crosslinked and post-cured film forming polymer for use according to the invention can exhibit less than a 250 percent weight gain in toluene after 24 hours. A similar composition comprising polymer that is not pre-crosslinked may experience substantially greater percent weight gain based on the same test, e.g., greater than 400 percent weight gain, greater than 800 percent weight gain, or may become substantially or totally dissolved.

As another example, certain compositions containing pre-crosslinked film forming polymer, when dried and preferably post-cured, can exhibit improved or relatively high resistance to heat. According to a Heat Sentinel test method described below, a dried composition that contains pre-crosslinked film forming polymer can exhibit a rating of “slightly sticky” or, preferably, “cured.” A composition that contains non-pre-crosslinked film forming polymer might exhibit a rating of “blocked” or “very sticky.”

As still another example, certain aqueous emulsions that contain pre-crosslinked film forming polymer, preferably that also contain an amount of thickener, can be coated onto a substrate and dried using less demanding drying conditions. This may be in the form of a lower drying temperature or reduced drying time compared to conditions needed to dry a similar aqueous emulsion that contains a similar film forming polymer that is not pre-crosslinked. As an exemplary approximate comparison, an embodiment of an aqueous emulsion coating according to the invention that contains from 0.5 to 3 weight percent thickener and from 30 to 40 percent solids (total solids, including film forming polymer, thickener, and release agent), coated to a coating weight of approximately 0.2 ounces per square yard (6.8 grams/square meter), may be substantially dried upon exposure to an oven temperature of 550 degrees Fahrenheit (F.) (288 degrees C.) to produce a web temperature of about 300 F (149 degrees C.) for a given time (e.g., 0.1 to 0.5 minutes). As a comparison, a similar aqueous composition that contains similar but not pre-crosslinked film forming polymer and no thickener may be dried in an identical amount of time, but would require a higher oven temperature, e.g., 650 F (343 degrees C.), to achieve a higher web temperature, e.g., 350F (177 degrees C.) (alternatively the same temperature could be used but for a longer amount of time). For the purposes of this comparison, “substantially dried” means dried to an amount to remove all but only a very small amount of residual water, preferably an amount substantially below about 1 percent of the total dried coating weight, preferably less than 0.5 percent of the total dried coating weight.

Many examples of non-pre-crosslinked film forming polymers are known in the polymer coating and release coating arts. These generally include polymeric organic hydrocarbon materials (optionally including hetero-atoms such as nitrogen or oxygen) prepared by polymerizing one or more unsaturated materials such as acrylate compounds, methacrylate compounds, vinyl compounds, and allyl compounds. Any presently available or future developed film forming polymer may be useful according to the invention if such polymeric material can be pre-crosslinked as described herein, e.g., to improve processing or final properties of an aqueous film forming polymer or of an aqueous low adhesion backsize composition on a coating that contains the film forming polymer, especially when used in combination with a thickener. Preferably, according to the invention, the pre-crosslinked film forming polymer does not include and can exclude covalently-bonded anti-adhesion or low-adhesion components such as those considered to be polysilicones, polysiloxanes, or that are fluorinated.

Pre-crosslinked film forming polymer that includes a polymeric network containing inter-connected linear or branched polymer can be prepared by reacting monofunctional monomers with multifunctional-materials. The monofunctional monomers each include one reactive group that is capable of reacting with a reactive group of another monofunctional monomer to produce a polymeric backbone. A multifunctional compound includes at least two and optionally three or more reactive groups, each of which can react with the monofunctional monomer to also form a polymeric backbone segment. When the separate reactive groups of a multifunctional compound become associated with separate polymeric backbone segments, an inter-connected (e.g., three-dimensional) polymeric network forms. In preferred embodiments, a film forming polymer can contain substantially only organic hydrocarbon-based materials, and need not include release-functional components such as polysiloxanes or fluorocarbon groups.

Exemplary film forming polymers that can be useful as pre-crosslinked film forming polymer include organic polymeric materials that are prepared from unsaturated materials, and that preferably can be suspended, emulsified, or dispersed in a predominately aqueous medium. Useful polymers can include vinyl acetate copolymers, styrene-butadiene copolymers, styrene-butadiene-acrylonitrile copolymers, copolymers containing acrylic and methacrylic esters, melamine-formaldehyde, urea-formaldehyde compositions, carboxylated vinyl acetate-ethylene copolymers, poly(vinyl butyral) and poly(vinyl acetal) dispersions, and water reducible alkyd resins.

Preferred monofunctional monomers for preparing pre-crosslinked polymeric materials according to the invention include monomers that contain a single unsaturated polymerizable group that reacts with a reactive group of another monomer to form a portion of a polymeric backbone. Preferred classes of monomers include vinyl monomers, allyl monomers, and (meth)acrylate monomers (meaning acrylate and methacrylate monomers) that are capable of forming polyvinyl, polyacrylate, or polymethacrylate copolymers.

Examples of specific monomers include organic compounds that do not contain silicone or fluorinated portions. Specific examples include: vinyl esters of alkanoic acids having from 1 to about 18 carbon atoms, such as vinyl formate, vinyl acetate, vinyl propionate, vinyl butyrate, vinyl isobutyrate, vinyl valerate, vinyl 2-ethylhexanoate, vinyl isooctanoate, vinyl nonoate, vinyl decanoate, vinyl pivalate, vinyl ester, vinyl laurate, and vinyl stearate; alpha-olefins, such as ethylene, propylene, butylene, isobutylene, and pentene and the like; maleate, fumarate, and itaconate esters of C1 to C8 alcohols, such as dibutyl maleate, dibutyl fumarate, dibutyl itaconate; alkyl acrylates such as methyl, ethyl, n-butyl, sec-butyl, the various isomeric pentyl, hexyl, heptyl, and octyl (especially 2-ethylhexyl), lauryl, cetyl, stearyl and like groups; alkyl esters of methacrylic acid such as methyl, ethyl, propyl, n-butyl, n-hexyl, 2-ethylhexyl, n-octyl, lauryl, cetyl, stearyl and like groups; vinyl alkyl ethers having an alkyl group with 1 to 18 carbon atoms, such as methyl vinyl ether, ethyl vinyl ether, butyl vinyl ether and stearyl vinyl ether. Examples of monomers also include diene monomers, such as butadiene, chloroprene, and isoprene and similar compounds. Other monomers include aromatic vinyl monomers, such as styrene, alpha-methylstyrene, vinyl toluene, 2-bromostyrene, and p-chlorostyrene; acrylonitrile; vinyl halide monomers such as vinyl chloride and vinylidene chloride; benzly acrylate and t-butyl acrylate; vinyl esters of aromatic acids such as vinylbenzoate; and ethylenically unsaturated aliphatic nitriles such as acrylonitrile, methacrylonitrile, ethylacrylonitrile, and the like.

To provide a pre-crosslinked film forming polymer according to the invention, a film forming polymer, in addition to monofunctional (backbone-forming) monomer, can be formed from multifunctional monomer. The multifunctional monomer includes at least two reactive groups capable of reacting with monofunctional monomer to incorporate the reactive group of the multifunctional compound into a polymeric backbone segment. The one or more other reactive groups of the multifunctional monomer will react with other monofunctional backbone-forming monomers to become incorporated into other polymeric backbone segments, to form a polymeric network connected through the multifunctional monomers.

Preferred multifunctional pre-crosslinking compounds include monomeric compounds that include at least two, optionally and preferably at least three, or more, reactive groups that can react with monofunctional monomer such that the reactive functionality of the multifunctional monomer assists in forming a polymeric backbone and the remainder of the multifunctional monomer connects to another backbone segment (by reaction of a second reactive functionality of the multifunctional monomer) to produce an interconnected (internally crosslinked) polymeric network.

The two or more reactive groups can be any reactive groups that can react with a monofunctional monomer during polymerization to become incorporated into a polymeric backbone. Preferred reactive groups for a multifunctional monomer can be unsaturated groups, e.g., unsaturated groups that react with preferred types of monofunctional monomer to produce a preferred polymeric backbone such as a polyvinyl, polyacrylate, or polymethacrylate backbone. Such unsaturated reactive groups include vinyl groups, allyl groups, acrylate groups, and methacrylate groups. A single multifunctional monomer may include different such reactive groups, but preferred multifunctional monomers can have two, three, or more of the same type reactive group. The multifunctional monomer provides pre-crosslinking of the film forming polymer, which means crosslinking and branching of the polymer that occurs during the formation of the film forming polymer, to increase the molecular weight of the polymer.

Examples of suitable multifunctional monomers include multifunctional (e.g., di- or tri-) allyl monomers; multifunctional (meth)acrylate monomers or oligomers such as tri-acrylate monomers and tri-methacrylate monomers; poly-vinyl, e.g., tri-vinyl monomers, divinyl aromatic compounds and divinyl esters; di-olefins. Some specific examples include alkylene glycol diacrylates and methacrylates such as ethylene glycol diacrylate, 1,3-butylene glycol diacrylate, propylene glycol diacrylate, triethylene glycol dimethacrylate etc., 1,3-glycerol dimethacrylate, 1,1,1-trimethylol propane dimethacrylate, 1,1,1-trimethylol ethane diacrylate, pentaerythritol trimethacrylate, sorbitol pentamethacrylate, methylenebisacrylamide, methylene bismethacrylamide; vinyl-functional compounds such as divinyl benzene, vinyl methacrylate, vinyl crotonate, vinyl acrylate, divinyl adipate; di- and tri-allyl compounds such as triallyl cyanurate, triallyl isocyanurate, diallyl phthalate, allyl methacrylate, allyl acrylate, diallyl maleate, diallyl fumarate, diallyl itaconate, diallyl malonate, diallyl carbonate, triallyl citrate, triallyl aconitate; divinyl ether; ethylene glycol divinyl ether and the like. Combinations of two or more of these monomers may also be useful.

The amounts of monofunctional and multifunctional compounds used to prepare a pre-crosslinked film forming polymer may be any amounts useful to achieve a useful or desired degree of crosslinking in the film forming polymer. Preferred amounts of each type of monomer can include amounts that (optionally in combination with other ingredients of a polymeric or backsize composition) result in a film-forming polymer or backsize composition that exhibits one or more of the advantages described herein, e.g., relating to coating or drying properties of a film forming polymer or an aqueous backsize composition thereof, or relating to final properties of a release coating containing or prepared from the pre-crosslinked film forming polymer, such as an adhesion property or heat or solvent resistance.

In addition to a degree of internal pre-crosslinking, a film forming polymer of the invention may optionally exhibit an ability to cure or post-react (post-crosslink) during or following coating of the film forming polymer to a substrate. For this, the pre-crosslinked film forming polymer can be prepared from reactive materials including a post-crosslinkable monomer, e.g., a monomer that contains two reactive functionalities, one that reacts with monofunctional monomer or multifunctional monomer during polymerization to form a segment of polymeric backbone, and one that is “post-crosslinkable,” meaning that it can be reacted later to cause further crosslinking of the polymer under different conditions, e.g., upon coating or drying of the film forming polymer, to cause even further crosslinking of the polymeric network. Such monomers may be referred to as “post-crosslinking” monomers, “post-crosslinkable” monomers, or latent crosslinking monomers. These include polyfunctional (generally bi-functional) monomers wherein one reactive group enters into the polymerization with other monomers during polymerization to form polymeric backbone of the film forming polymer, and a second reactive group does not react during polymer formulation but remains reactive and available to be reacted and cause further crosslinking of the already pre-crosslinked polymer upon the subsequent application of energy, e.g., after coating, generally by applying heat that can dry and cure the polymer, optionally in the presence of a catalyst or by applying radiation. A post-crosslinkable monomer can provide thermosetting characteristics to the pre-crosslinked film forming polymer.

Preferred post-crosslinkable monomers can have one unsaturated group able to react with a monofunctional monomer to produce a polymeric backbone, such as a vinyl, an allyl, or a (meth)acrylate group. Also preferably, the second functional group can be a self-crosslinkable group. A self-crosslinkable group is a group that can cause crosslinking between polymeric segments by reacting with another (e.g., similar or identical) reactive group on another polymeric segment, without the presence of an additional, separate multifunctional crosslinking compound such as a multifunctional compound of the type sometimes referred to as a crosslinking agent or crosslinker, which separate compound would produce crosslinking by reacting with both functionalities of the separate polymeric segments.

Examples of post-crosslinking monomers include: acrylamide, N-alkylolamides of alpha, beta ethylenically unsaturated carboxylic acids having 3-10 carbons such as N-methylol acrylamide, N-ethanol acrylamide, N-propanol acrylamide, N-methylol methacrylamide, N-ethanol methacrylamide, N-methylol malemide, N-methylol maleamide, N-methylol maleamic acid, N-methylol maleamic acid esters; the N-alkylol amides of the vinyl aromatic acids such as N-methylol-p-vinylbenzamide and the like; N-(alkoxymethyl) acrylates and methacrylates where the alkyl group has from 1-8 carbon atoms such as N-(methoxymethyl) acrylamide, N-(butoxymethyl) acrylamide, N-(methoxymethyl) methacrylamide, N-(butoxymethyl) allyl carbamate, N-(methoxymethyl) allyl carbamate, and mixtures of these monomers with allyl carbamate, acrylamide, or methacrylamide. Alternately, epoxy-containing monoethylenically unsaturated compounds such as glycidyl acrylate, glycidyl methacrylate, and vinyl glycidyl ether may function as self-crosslinking, post-crosslinkable monomers in conjunction with mono- and diethylenically unsaturated carboxylic acid monomers such as acrylic methacrylic and itaconic acid, when catalyzed with an alkaline catalyst such as potassium or sodium carbonate, diethylenetriamine, and the like. Hydroxyethyl acrylate, hydroxypropyl acrylate and the corresponding methacrylates provide latent crosslinking when combined with N-alkylolamides of alpha, beta ethylenically unsaturated acids having 3-10 carbon atoms or with the acids themselves by ester formation.

Useful and preferred amounts of various monomers for preparing a pre-crosslinked (optionally post-crosslinkable) film forming polymer will vary depending on factors such as the chemistry of the film forming polymer; the particular chemistry of monofunctional monomer, optional post-crosslinkable monomer, and multifunctional monomer; the number of reactive groups on a particular multifunctional monomer (e.g., 2, 3, 4, or more); and the use of other specific ingredients in a film forming polymer composition such as a thickener, dispersing agent, surfactant, etc. With that in mind, amounts of monofunctional backbone-forming monomer useful to produce a preferred pre-crosslinked film forming polymer may be from about 50 to 99 weight percent, preferably from 70 to 99 weight percent, based on the total weight of monomer; amounts of post-crosslinkable monomer useful to produce a preferred pre-crosslinked film forming polymer may be from 0 to 5 weight percent, based on the total weight of monomer; and amounts of multifunctional, e.g., trifunctional monomer useful to produce a preferred pre-crosslinked film forming polymer may be from 0.5 to 5 weight percent multifunctional compound, e.g., from 1 to 4 weight percent, based on the total weight of monomer.

In a particular embodiment of the invention, when triallyl cyanurate is included as a multifunctional monomer to produce a pre-crosslinked film forming poly(vinyl acetate), optionally also including a post-crosslinkable monomer such as N-methylolacrylamide, triallyl cyanurate may preferably be used in an amount in the range from 0.5 to 5 weight percent triallyl cyanurate based on total monomer, more preferably in an amount from 1 to 3 weight percent, e.g., from 1 to 2 weight percent triallyl cyanurate based on total monomer.

Another example of a pre-crosslinked film forming polymer that may be useful according to the invention can be derived from monomer comprising vinyl acetate, butyl acrylate, trially cyanurate, and N-methylol acrylamide. When these monomer are used in combination, exemplary relative amounts of the monomers may be from 70 to 99 weight percent vinyl acetate, from 0 to 30 weight percent butyl acrylate, from 0.5 to 5 weight percent triallyl cyanurate, from 0.5 to 4 weight percent N-methylol acrylamide, and from 0 to 5 weight percent acrylamide, based on the total weight of monomer.

Preferably, a film forming polymer composition for use according to the invention can be an aqueous composition that contains non-aqueous particles of insoluble pre-crosslinked film forming polymer dispersed, suspended, or emulsified within a continuous aqueous phase. Often, an aqueous composition that contains polymeric particles of average diameter of less than about 1 micron or 10 microns (μm) suspended in a continuous aqueous phase can be referred to as an emulsion, and compositions that contain polymeric particles of average diameter greater than 10 microns can be referred to as dispersions or suspensions. Aqueous film forming polymer compositions according to the invention can contain particles of average diameters that are within any of these descriptions. A preferred aqueous film forming polymer composition can be in the form of an aqueous emulsion comprising particles of insoluble pre-crosslinked film forming polymer distributed in a continuous aqueous phase. The particles can be, e.g., of average diameter less than or equal to 6 or 5 microns (μm), e.g., less than or equal to 1.0 micron or less than or equal to 0.5 micron. (The size of particles of the polymerized film forming polymer can be affected, e.g., by the type of surfactant used during polymerization).

The pre-crosslinked film forming polymer, e.g., in the form of an emulsion, can be used in a low adhesion backsize composition in combination with a release agent. Examples of release agents include low molecular weight materials and oligomeric and polymeric materials that may be polysilicones, polysiloxanes, organic materials such as poly(meth)acrylates, especially poly(meth)acrylates that include long chain (ten or more carbon atoms) alkyl groups, e.g., organic surfactants, and materials that include fluorinated or perfluorinated portions (e.g., fluorinated surfactants). The release agent can preferably be separate from the film forming polymer, meaning not covalently bonded to the film forming polymer as a segment of the backbone or as a pendant group. Normally a release agent is substantially hydrophobic and will be present in an aqueous composition in the form of water-insoluble suspended particles. This also means that when present in an aqueous low adhesive backsize composition, a release agent tends to be present in water-insoluble, dispersed, suspended, or emulsified particles. On the other hand, as part of a dried release coating, a release agent can preferably be mechanically bound to a substrate by interaction with the film forming polymer. In this arrangement the release agent can provide low adhesion properties when coated onto a substrate in combination with the pre-crosslinked film forming polymer.

Examples of useful release agents are known and understood in the arts of pressure sensitive adhesive products and low adhesion backsize compositions. A small number of examples include release agents sometimes referred to as nonionic surfactants, long chain alkyl carboxylic acids and their salts, silicone copolyols, and fluorochemical surfactants. Many types of general and specific release agents are described, for example, at Kenning and Schneider, “Adhesion Science and Engineering—Surfaces, Chemistry, and Applications, Chapter 12 (Release Coatings for Pressure Sensitive Adhesives, pages 535-71 (2002) (ISBN: 0-444-51140-7). Examples of general low adhesion chemistries described therein include hydrocarbon materials, fluorocarbon materials, and polydimethylsiloxane materials. More specific chemistries described include silicone acrylates, fluoropolymers such as TEFLON and fluorinated waxes, perfluoropolyethers, fluorosilicones, alkyl side chain polymers including copolymers based on higher alkyl acrylates or methacrylates, polyvinyl esters of higher aliphatic fatty acids, higher alkyl vinyl esters or ethers and a maleic acid, fluoroalkyl side chain polymers, silicone-organic copolymers and networks, and polyolefins such as polyethylene and polypropylene, among others.

An example of one general class of release agent that may be useful in a low adhesion backsize composition of the invention is the class of block copolymers that include a polysiloxane block and a polymeric hydrocarbon block. The polysiloxane block may be a polydiorganosiloxane, with polydimethylsiloxanes being sometimes preferred. Preferred hydrocarbon blocks may include hydrophobic materials such as polyoxyalkylene groups pendant from a polydiorganosiloxane backbone.

Examples of block copolymer release agents are described in U.S. Pat. No. 6,552,212, the entire disclosures of which is incorporated herein by reference. The block copolymers include a polydiorganosiloxane backbone block and pendant polyoxyalkylene blocks. The polyoxyalkylene blocks include a non-hydroxy (—OH) terminal group, e.g., a polyoxyalkylene block terminal group can be alkyl, aryl, or a functional derivative of a carboxylic acid. The polyoxyalkylene block can be “end-capped” to include a non-hydroxy terminal group, preferably an organic group that improves release properties of the block copolymer compared to the block copolymer with a terminal hydroxy group at the polyoxyalkylene block. Particularly preferred such terminal groups can include ester and carbamate groups such as alkyl esters, aryl esters such as benzoate esters, alkyl carbamates, and aryl carbamates. Examples of such block copolymers include block copolymer having the formula:

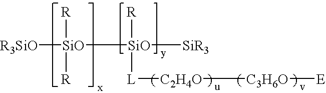

In the above formula, each E can preferably be an end group that is not hydroxy. Preferably each E can be a terminal group that improves release performance of the block copolymer compared to a similar block copolymer having a hydroxy terminal group. Examples of such terminal groups may include alkyl (e.g. C1-C18 alkyl), aryl, and fuictional derivatives of carboxylic acid such as esters, amides, urethanes (carbamates), ureas, and carbonate esters. Particularly preferred E terminal groups can include esters and carbamates, e.g., alkyl esters, aromatic esters, alkyl carbamates, and aromatic carbamates.

Also in the formula, each L can independently be a linkage such as a single bond, a lower alkoxylene (e.g., a C2 to C5 alkoxylene), or a lower alkylene (e.g., a C2 to C5 alkylene);
each R can be independently selected from the group consisting of alkyl or aryl groups, preferably methyl, ethyl, linear propyl, and linear butyl;
each u can be from about 1 to about 50;
each v can be from about 0 to about 50, e.g., from about 1 to about 50;
each x can be from about 1 to about 50; and
each y can be from about 1 to about 50.

Preferred block copolymer can include one polysiloxane block and one or more pendant polyoxyalkylene blocks, with each polyoxyalkylene block preferably being end-capped or otherwise terminated with an alkyl, an aryl, or a functional derivative of a carboxylic acid (e.g., a carbonyl ester or a carbamate). Each polyoxyalkylene block can itself be made up of random oxyalkylene units or repeating oxyalkylene units such as a polyoxyethylene block or a polyoxypropylene block. Multiple homopolymeric or copolymeric polyoxyalkylene blocks can be attached to each other, such as when a homopolyoxyethylene block is attached to a homopolyoxypropylene block and the homopolyoxyethylene block connects to the polysiloxane block.

The particular release agent and the amount included in a low adhesion backsize composition can be selected based on factors such as- the desired-release properties (e.g., level of adhesion) and the type of pressure sensitive adhesive with which the backsize composition will be used.

The amount of release agent included in a low adhesion backsize composition can be any amount that provides useful release properties. Particularly useful or preferred amounts can depend on factors such as the type of release agent, the type of film forming polymer, the type of pressure sensitive adhesive for use with the low adhesion backsize of a particular product construction, and other factors as will be appreciated. Exemplary amounts can be in the range of from 5 to 60 weight percent release agent, e.g., from 10 to 50 weight percent, based on the total solids in a low adhesion backsize composition.

The low adhesion backsize composition may additionally contain other useful ingredients or coating aids, and according to the present invention includes thickener. Thickener can be included generally in a backsize composition to increase viscosity and improve coating properties of a substrate, e.g., to allow a liquid (e.g., aqueous emulsion) coating to remain as a continuous or semi-continuous film on a surface of a substrate for an amount of time that allows drying to form a useful continuous or semi-continuous film. Useful thickeners may include thickeners synthetic and natural polymeric materials that can affect Theological properties of a film forming polymer or backsize composition such as viscosity. Preferred thickeners for use according to the invention can also improve one or more of the stability of a film forming polymer or backsize composition, or the coating or drying properties of a film forming polymer or backsize composition. Preferred thickeners can be water soluble polymeric materials that are relatively non-reactive with other ingredients of a low adhesion backsize composition.

A useful amount of thickener can be an amount that allows for desired rheology properties, coating and drying properties, or stability properties of a film forming polymer or backsize composition. An amount of thickener that may be useful can depend on factors such as the desired viscosity and drying properties of a particular backsize composition as well as the types and amounts of other ingredients used in a backsize composition. According to the invention, the use of a pre-crosslinked film forming polymer in an aqueous backsize composition may improve coatability of a backsize composition, thus potentially reducing the amount of thickener that will be required to produce a continuous or semi-continuous film from the aqueous backsize composition and allow it to be dried. Exemplary amounts of thickener (solids) can be in the range from 0.1 to 3 weight percent, e.g., from 1 to 2 weight percent, based on total solids of an aqueous low adhesion backsize composition.

Thickener can be added to a pre-crosslinked film forming polymer, to ingredients thereof, or to a low adhesion backsize composition, at any useful stage of processing prior to coating. A useful stage of processing for addition of thickener to a film forming polymer or a backsize composition can be after formation of an aqueous composition containing the film forming polymer. Alternatively, preferred embodiments of the invention can include addition of thickener to an aqueous polymerization composition, e.g., an aqueous monomer-containing emulsion, prior to completion of polymerization of a mixture of monomers that react to form a pre-crosslinked film forming polymer. For example, thickener can be added during an aqueous polymerization process, preferably at a stage that results in the formation of film forming polymer particles that will be especially stable when suspended, dispersed, or emulsified in a continuous aqueous phase of an aqueous low adhesion backsize composition.

A variety of different types of thickeners may be useful with an aqueous backsize composition of the invention depending on factors such as the chemistry of the pre-crosslinked film forming polymer, the degree of pre-crosslinking of the film forming polymer, the identity of other ingredients such as release agent, and desired properties of the aqueous backsize composition or its derivative coatings. In general, a thickener may function to increase viscosity or stability of a composition at the pH of the composition; may preferably not unduly inhibit preparation of a film forming polymer or cause coagulation; and may not unduly inhibit or interfere with any of drying, curing, or other post-polymerization or post-coating processing or reaction of a backsize composition.

Certain prefer-red polymer and backsize compositions described herein produce a prevailing acidic pH when used in the form of an aqueous composition. For example, poly(vinyl acetate) polymers and copolymers typically exist in aqueous emulsion at a pH in the range from 3.5 to 5.5, e.g., 4 to 5. As such, when a backsize composition according to the invention includes this or another polymer that produces an acidic pH, preferred thickeners can provide a useful thickening effect when used within this acidic pH range.

Exemplary classes of thickeners that may be effective within low pH ranges can include polymethacrylamide, polyvinyl pyrrolidone, polyvinyl alcohol (both partially hydrolyzed and fully hydrolyzed), polymaleic acid, polycrotonic acid, and derivatives of polymaleic acid methylvinyl ether.

Another class of useful thickeners that tend to be efficient under acidic conditions include cellulosic materials (including cellulose and functionalized cellulose or cellulosic materials) of various molecular weights. These can be formed by reaction between cellulose of various molecular weights and cyclic ethers. Examples of useful cyclic ethers include methylene oxide, ethylene oxide, propylene oxide, butylene oxide, with ethylene oxide sometime being preferred. These thickeners include carboxymethyl cellulose, carboxyethyl cellulose, and hydroxymethyl cellulose, with hydroxyethyl cellulose sometimes being preferred.

Another example of thickener that tends to be efficient under acidic conditions includes the class of polyacrylates (polyacrylic acids) and their derivatives, prepared by the alkaline hydrolysis of acrylate ester emulsions of various molecular weights, or their corresponding salts. A particularly preferred polyacrylic acid can be sodium polyacrylate. Examples of commercially available sodium polyacrylate thickener are available from Southern Chemicals and Textiles, Inc., of Dalton Georgia, under the trade name KA-2000, KA-2001, KA-2003, and KA-114. Such polymeric thickeners can be made by aqueous polymerization of acrylate esters that include methyl acrylate, ethyl acrylate, or a combination of these monomers optionally with other monomer. These can be polymerized to produce homopolymers or copolymers of a desired molecular weight. These polymer emulsions are then hydrolyzed or saponified with an alkaline metal hydroxide such as lithium, sodium, or potassium, forming the neutralized polyacrylic acid and corresponding alcohol.

Preferred thickeners can generally be of a molecular weight that provides useful, preferred, or optimum viscosity for coating and drying of an aqueous low adhesion backsize composition, preferred stability, or combinations of preferred such properties. Relative molecular weight may affect the amount of a thickener that is needed to achieve one or more of the preferred properties. If a relatively-high molecular weight thickener is used, a lower amount may be required to avoid unduly high viscosity or to avoid gelation of a film forming polymer or backsize composition. If lower molecular weight thickener is used, a relatively higher amount may be needed to achieve desired coating and drying properties.

A thickener may preferably result in improved stability of a film forming polymer composition or of a backsize composition that includes the film forming polymer composition and release agent. This can mean that the polymer composition or the backsize composition exhibits improved stability compared to the same composition that does not contain the thickener. A stable polymer or backsize composition can be considered to be a composition (e.g., an aqueous composition) that maintains polymeric particles in a dispersed, suspended, or emulsified state in a continuous phase (e.g., a continuous aqueous phase) over a period of at least 24 hours, more preferably at least 3 days, even more preferably at least 7 days, or up to or exceeding 1 month or 3 months, when held at room temperature (25 C), at substantial rest, without the need to continuously agitate or to re-disperse the polymer particles. Unstable aqueous compositions, for comparison, can separate into stratified layers that include predominantly polymer particles and continuous phase, such as one layer of polymer particles and one layer of substantially water.

The thickener can be in any form, such as a liquid or a solid (e.g., powder) thickener that can be dissolved in organic or aqueous solvent, or that can be dispersed or suspended in an organic or aqueous continuous phase. Preferred solvent or liquid phases can be aqueous, e.g., water-based, to avoid safety problems associated with volatile or flammable organic materials. To facilitate processing, a thickener can preferably be added as part of a liquid, because liquid thickeners may tend to be easier to uniformly incorporate and distribute into a liquid emulsion, thereby avoiding the possibility of coagulation or gelation of the monomer or polymer emulsion during polymerization. Thickeners, when added during formation of a film forming polymer, can preferably be pre-heated to match the temperature of a polymerization reaction, prior to being added to reactants.

An aqueous low adhesion backsize composition, e.g., an aqueous emulsion, dispersion, or suspension, can include any useful amounts of film forming polymer, release agent, thickener, or other ingredients. Examples of amounts of ingredients useful in aqueous low adhesion backsize compositions may be from about 50 to 99 weight percent film forming polymer, and from about 1 to 60 weight percent release agent, based on total solids, with a useful amount of thickener. A preferred amount of thickener can be an amount that improves coating or drying properties or stability of a backsize composition relative to a similar backsize composition that contains no thickener. Useful and preferred amounts may vary depending on factors such as the type of thickener and the type of film forming polymer, among other factors. Exemplary amounts of thickener can be from about 0.1 to 3 weight percent thickener based on total solids, although amounts outside of this range may also be useful.

A pre-crosslinked film forming polymer can be prepared by polymerization methods that will be understood by those of skill. For example, pre-crosslinked film forming polymer as described herein can be prepared using water-based (aqueous) polymerization methods, e.g., suspension, dispersion, and emulsion polymerization methods, with these terms all being considered water-based or aqueous polymerization methods.

Aqueous polymerization methods are known in the arts of polymers and polymeric materials preparation. According to these methods, monomers can be combined in an aqueous phase (e.g., water), dispersed, and then caused to polymerize, typically by free-radical polymerization methods. Batch and semi-batch processes are typical. The monomers are often dispersed with the assistance of surfactant, dispersant, or emulsifying agent, and mechanical agitation or shear, to produce non-aqueous particles of water-insoluble monomer dispersed or suspended in a continuous aqueous phase, sometimes referred to or known as “micelles.” The particles can be of a size that promotes polymerization, that prevents substantial gelation, and preferably that results in a stable low adhesion backsize composition such as a stable aqueous dispersion. Polymerization can be accomplished with one or more of heat, use of an initiator, or by use of a catalyst. Upon reaction, thermal energy may desirably be removed.

A variety of surfactants, dispersants, or emulsifying agents may be useful to prepare aqueous compositions containing suspended or dispersed particles of film forming polymer. These may include ionic materials, non-ionic materials, anionic materials, amphoteric materials, etc., as will be appreciated by those of skill. It will be recognized that homologous cationic systems, using cationic surfactant and cationic thickener, may also be prepared.

One example of a general class of useful surfactant is the class of nonionic polyoxyalkylene surfactants such as nonionic polyoxyethylene/polyoxypropylene surfactants. Other examples include the general types of anionic surfactants, including alkylaryl sulfonates and sulfates, diphenyl sulfonate derivatives, olefin sulfonates and sulfates, sulfonates and sulfates of ethoxylated alkylphenols, sulfated alcohols, sulfated ethoxylated alcohols, sulfosuccinamates, sulfosuccinates and derivatives. Mixtures of different varieties of surfactants, emulsifying agents, and dispersants, may also be useful or preferred. Useful amounts of any of these materials, especially non-ionic surfactant, are also useful to affect the size (average diameter) of particles of water-insoluble monomer or (after-polymerization) polymer suspended in an aqueous phase. Generally, useful amounts of these ingredients may be in the range of from about 0.5 to about 5 weight percent based on the total weight of the aqueous composition.

An aqueous polymerization may take place based on the use of a desired initiator, as will be understood. An initiator can be any material that will initiate a polymerization reaction, typically by introduction of a free radical material that will propagate polymerization of functional groups of a monomer. A particular type of initiator used can depend, for example, on the type of monomer used. For poly(vinyl acetate) polymers, an example of a useful initiator is sodium persulfate. Useful amounts of initiator will also be appreciated and understood, and may be, for example, in the range of from about 0.1 to about 0.5 weight percent based on the total weight of the aqueous composition.

Optionally, aqueous polymerization to form film forming polymer may be performed in multiple stages, with addition of monomer during an initial reactor charge and further addition of monomer and other ingredients after polymerization has begun. According to certain embodiments of processes of the invention, an aqueous polymerization method can include stage-wise addition of reactive monomers, preferably in combination with the addition of thickener after at least a portion of the total amount of monomer has been polymerized. The stage-wise addition of monomer can be as separate additions of monomer added continuously or in discrete amounts to a reaction, or can be added as a mixture of materials added in discrete amounts or preferably continuously over a desired period of time while the reaction proceeds in the reactor. Addition of thickener after polymerization has started but before polymerization has been completed, can improve or control stability of a resultant film forming polymer composition or of a low adhesion backsize composition prepared from the film forming polymer composition.

It has been found that particularly stable aqueous film forming polymer compositions (e.g., aqueous emulsions) can be prepared by aqueous polymerization methods by adding thickener after polymerization of a portion of a total amount of monomer to be polymerized, followed by polymerization of the remaining portion of monomer. According to preferred emulsion polymerization methods, aqueous emulsions that contain film forming polymer can be prepared which are relatively stable, e.g., which maintain polymeric particles in a dispersed, suspended, or emulsified state, substantially uniformly throughout a continuous phase, for a period of at least 24 hours, more preferably at least 3 days, even more preferably at least 7 days, or up to or exceeding 1 month or 3 months, when held at room temperature (25 C), at substantial rest, and without the need to continuously agitate or to re-disperse the polymer particles. Unstable aqueous compositions, for comparison, can separate into stratified layers of polymer particles and continuous phase.

Also advantageously, it has been found that such aqueous film forming polymer compositions (e.g., emulsions) can be combined with release agent to form aqueous low adhesion backsize compositions (e.g., emulsions) that exhibit similar stability properties. For example, an aqueous backsize composition can be prepared that contains film forming polymer, release agent, and thickener, wherein the composition is relatively stable, e.g., the composition can maintain polymeric particles in a substantially uniform dispersed, suspended, or emulsified state, throughout a continuous (e.g., aqueous) phase over a period of at least 24 hours, more preferably at least 3 days, even more preferably at least 7 days, or up to or exceeding 1 month or 3 months, when held at room temperature (25 C), at substantial rest, and without the need to continuously agitate or to re-disperse the polymer particles.

One particularly preferred method of producing a stable aqueous emulsion backsize composition can be a batch emulsion polymerization process wherein thickener is added at a time after a portion of monomer has been polymerized. An exemplary method may begin by dispersing a portion of a total amount of monomer into an aqueous dispersion followed by polymerization to produce a seed particle, preferably with no thickener. An initial charge of monomer can be an amount of monomer useful to produce seed particles, and can be added to a reactor followed by initiation of polymerization (e.g., by addition of initiator with heating to an effective temperature, such as from 70 to 80 degrees Celsius). The polymerization of the initial portion of monomer in the reactor can establish an initial polymeric seed size (e.g., average particle diameter in the range from 5 to 50 nanometers), which can be stabilized by surfactant. Separately, a charge of additional monomer can be prepared to contain water soluble and water insoluble ingredients, e.g., water soluble surfactant or emulsifier, preferably with mixing, followed by addition of water-insoluble ingredients (e.g., monomers). This separate charge of an additional portion of monomer preferably does not include thickener. The separate charge of monomer (e.g., “delayed” monomer charge) can be added to the reactor over time, while polymerization proceeds in the reactor. The addition can be continuous or in discrete amounts.

According to such a preferred method of emulsion polymerization, thickener can be added at a time, after polymerization has begun, e.g., after a portion of monomer has been added and reacted, that results in a particularly stable resultant aqueous polymeric composition. The particular timing of thickener addition that will result in preferred stability can depend on factors relating to the polymerization process and ingredients, such as polymerization conditions (e.g., temperature) and the identity and amounts of monomer, initiator, thickener, etc. If thickener is added too early during polymerization (e.g., before a large enough portion of the total amount of monomer has been added), particle size can become too large, potentially resulting in instability of the composition in the form or short-term or longer-term coagulation or gelation. On the other hand, if thickener is added too late (e.g., after too large a portion of the total monomer is added), a resultant polymeric composition may contain smaller particles-that may not be stable over time, possibly becoming un-dispersed over time. Of these two possibilities, a preference is for particles that are smaller rather than larger. Larger particles may coagulate during polymerization, resulting in a coagulated mass of polymer being formed in the reactor, which must be removed with difficulty. If particles are too small, a result of separation of the particles from dispersion, emulsion, or suspension, over time, can normally be corrected by re-dispersing the particles. A dispersion that does not coagulate during polymerization, yet does not need to be re-dispersed, is most preferred, because this avoids the need for expensive equipment at the point of use such as re-dispersing equipment at a holding tank or coating station. Certain particularly stable polymeric emulsions prepared according to the invention can have a mean particle size that produces such stability, e.g., a mean particle diameter be in the range from 100 to 1500 nanometers, e.g., from 150 to 350 nanometers.

Accordingly, thickener can preferably be added at a time during a process of aqueous polymerization of monomers that results in a polymer that does not coagulate during polymerization and that is also stable over time to avoid the need for re-dispersing the polymer. It may be preferred to not include thickener during the early stages of the polymerization, e.g., during initial polymer charge, or during the first quarter or the first third of addition and polymerization of delayed monomer charge. Generally it may be preferred to add thickener during the middle portion of a polymerization reaction, e.g., during the middle third of the reaction, which would be the time after ⅓ of the total polymerization reaction has occurred until the time prior to ⅔ of the total polymerization being completed. (The total time of polymerization for a batch polymerization process can be taken to mean the time from initializing polymerization of either an initial reactor charge or a subsequent monomer charge that is added over time (by delayed additions), until the end of the addition of monomer, or until a short time after all monomer is added and the polymerization reaction ends.) With certain aqueous batch polymerization processes that proceed for a polymerization time in the range from 150 to 250 minutes (e.g., an initial monomer charge is reacted for a short time, such as about 10 minutes, and a delayed monomer charge is added over a period of from 150 to 250 minutes), according to embodiments of the invention thickener may preferably be added at a time after ⅓ of the delay monomer charge is has been added, e.g., near the half-way point of the process of adding a delayed monomer charge, such as at a time in the range between 90 minutes and 130 minutes following the start of addition of a delayed monomer charge, e.g., at about 120 minutes following the start of addition of a delayed monomer charge.

An aqueous backsize composition according to the invention may be prepared by combining the pre-crosslinked film forming polymer (e.g., in the form of an aqueous emulsion) with a useful amount of release agent, and optionally with other ingredients (e.g., water, organic solvent, or a mixture). The relative amounts of film forming polymer and release agent can be any relative amounts useful to allow the aqueous composition to be coated to a substrate and dried and optionally cured to provide a dried coating with desired release properties. Mixing may be required to combine the film forming polymer and a release agent into an aqueous or organic solvent-based liquid solution, emulsion, or dispersion. The release agent may take the form of particles that are emulsified or dispersed or suspended within in the aqueous phase of the aqueous film forming polymer composition (e.g., “co-dispersed” or “co-suspended” or “co-emulsified” among particles of film forming polymer), or the release agent may become dissolve in or otherwise contained in the aqueous phase.

One example of an aqueous backsize composition can be an aqueous backsize composition containing an aqueous emulsion film forming polymer and dispersed, suspended, or dissolved release agent, and thickener and other additives. Such an aqueous composition may include from about 30 weight percent to about 55 weight percent total solids and from about 45 to about 70 weight percent of non-solid liquid phase (e.g., water or organic solvent). Of the non-solid liquid phase, it is preferably aqueous, e.g., less than 50 percent, preferably less than 10 percent or less than 5 percent, organic solvent. Thus, preferred water-based or “aqueous” backsize compositions (suspensions, dispersions, or emulsions) do not require added organic solvent, and, while amounts of organic solvent may be included, aqueous backsize compositions of the invention can preferably include less than 50 percent by weight organic solvent based on the total amount of liquid phase. Preferably, if included at all, an aqueous composition can include even lower amounts of organic solvent, such as below 20 weight percent, e.g., less than 10 percent or less than 5 percent, based on the total amount of liquid phase (water plus organic solvent). Certain raw materials of an aqueous backsize composition may include amounts of organic solvent, e.g., due to a processing history that includes organic solvent. Such an amount of organic solvent can be included in an aqueous backsize composition of the invention.

Other ingredients may be included in an aqueous backsize composition of the invention, as will be appreciated by those of skill in the backsize coating arts. Examples of useful ingredients may include one or more of additional organic solvent, emulsifier, surfactant, dispersant, thickener, defoamer, biocides, pigments, pigment dispersing agents, fillers, buffers, coalescents, heat stabilizers, wetting agents, dyes, coupling agents, ultraviolet light absorbers, colorants, preservatives, antifoaming agents, catalyst, etc., as may be desired or needed, and as will be understood by one of skill in the release coating arts.

As an example, an aqueous low adhesion backsize composition, if post-crosslinkable, may also include a catalyst that can catalyze a post-crosslinking reaction. Certain post-coating crosslinking or curing reactions may occur based on heat and preferably in the presence of an acid catalyst. As one example, post-crosslinkable film forming polymers that include N-alkylol(meth)acrylates can be catalyzed to react (self-crosslink) at the alkylol groups, especially a methylol or butylol group, with an acid catalyst such as a Lewis acid. Specific alkaline catalyst compounds can include potassium or sodium carbonate and diethylenetriamine.

According to one embodiment of an aqueous backsize composition, a backsize can be formed to include from about 33 to about 37 percent solids, including film forming polymer, thickener, and release agent. A specific type and amount of release agent can be included in the aqueous composition as desired for a specific application, e.g., for use with a specific pressure sensitive adhesive or to achieve specific adhesion or release properties. Subsequently, perhaps by a user who coats the backsize composition onto a substrate, the low adhesion backsize composition may be further modified or optimized for coating properties, for example by diluting with water to produce a specific viscosity. An example of a viscosity for coating (viscosity of a diluted composition) may be in the range from 100 to 200 centipoise, which may in certain embodiments of the invention be achieved by diluting with water to a solids content in the range from about 30 to about 33 percent total solids. Viscosity in this instance can be measured at 25 degrees Celsius using a Brookfield model RVT viscometer, with spindle #3 at 20 revolutions per minute (rpm) or with spindle #2 at 10 rpm.

A low adhesion backsize composition can be applied to a backing using conventional methods such as knife coating, roller coating, gravure, wire-wound rod, reverse roll, air-knife, blade, spray coating, curtain coating, print coating, or other useful conventional or non-conventional coating methods.

After being applied to a backing, a coating may be dried by any useful method, and optionally cured (e.g., by heat). To dry, a low adhesion backsize composition can be treated with heat at a desired time and temperature to remove the water. During this drying process, the particles of the aqueous low adhesion backsize composition will coalesce and optionally crosslink, depending on the temperature. The backsize composition preferably forms a coherent film which, as water is removed and upon crosslinking, contains a developing polymer network of the film forming polymer wherein the film forming polymer contains the release agent in a structure that will allow the release agent to function as an anti-adhesive coating for a pressure sensitive adhesive. Aqueous pre-crosslinked film forming polymer compositions and low adhesion backsize compositions that contain the pre-crosslinked film forming polymer can exhibit improved drying behavior compared to similar compositions that contain non-pre-crosslinked polymer. This can mean, for example, that drying of a given aqueous low adhesion backsize coating can be accomplished using less severe conditions such as one or more of a lower oven or film temperature or a shorter drying time. This can lead to improvements in efficiency and cost by use of one or more of smaller drying ovens, less heat energy for drying, or faster line speeds.

Embodiments of aqueous backsize composition can be cured (e.g., crosslinked) either during or following coating or drying. Whether a backsize composition can be cured can depend on the formulation, particularly the type of monomers used to prepare the film forming polymer used in the backsize composition. Examples of post-crosslinkable film forming polymers include polymers that cross-link by addition or condensation reactions, with one particularly preferred mechanism being reaction of methylol functionalities that have active hydrogen functionalities.

The wet and dry coating weights of a coated backsize composition can be any wet or dry coating weight useful to allow coating and processing of the aqueous backsize composition to a dried release coating. Specific wet and dry coating weights may vary widely depending on a number of considerations including the type of release coating desired, e.g., release value; the type of substrate; the composition of the aqueous backsize composition, such as the relative amounts of film forming polymer and release agent, and their individual chemical compositions; the type of pressure sensitive adhesive or other product to be used with the release coating; and even the equipment and conditions used to prepare the liquid or dried coating. Those of skill in the release coating arts will appreciate these factors and will be able to identify useful wet and dry coating weights for applying different embodiments of inventive aqueous backsize compositions to substrates, to form useful release coatings.

Substrates that may be useful according to the invention can be any suitable substrates known in the art. Examples of useful backings include films, foil, paper, nonwovens, wovens and composites thereof. They may be porous or nonporous, rough or substantially smooth. The base film or sheet of the pressure sensitive adhesive tape or contact sheet, and the base sheet of the protecting cover sheet are not particularly limited, and include, for example, thermoplastic films and sheets made of polyethylene, polypropylene, polyester such as polyethylene terephthalate, and cellophane, i.e., cellulose acetate; papers such as saturated paper, woodfree paper, Kraft paper, crepe paper and glassine paper; seal-coated papers such as impregnated paper and plastic-coated paper; and cloths. The coated surface of plastic film or sheet may be surface-treated by a conventional surface-treating procedure such as corona discharge treatment or plasma treatment.

One embodiment of the invention is a pressure sensitive adhesive tape including a backing having an adhesive-coated side and a release-coated side. In this embodiment, the backing is wound onto itself so that the adhesive-coated backing side is placed in physical contact with the release-coated backing side.

Another embodiment of a coated product according to the invention can be a release liner, comprising a desired backing and one surface coated-with a release coating as described herein.

In another embodiment, one or both sides of a backing can be coated with adhesive (double adhesive-coated backing), and a separate release liner coated on one or both sides with a release coating, can be used to contact one or both sides of the adhesive-coated backing sides.

Pressure sensitive adhesives that are useful according to the present invention include conventional materials typically used and known in the art. Examples of pressure sensitive adhesives include, but are not limited to, natural rubber adhesives; butyl rubber adhesives; vinyl ether adhesives; acrylic adhesives; solvent-based rubber adhesives including cis-1,4-polyisoprene; block copolymer adhesives including styrene-butadiene-styrene block and styrene-isoprene-styrene block copolymers; hot-melt block copolymer adhesives; synthetic rubbers including styrene-butadiene rubber; silicone based pressure sensitive adhesives; and the like.

### EXAMPLES

Following are examples of aqueous film forming polymer compositions that include a high degree of internal crosslinking, a post curing chemistry that is activated upon drying during the film formation process, and a water soluble polymer thickener of a molecular weight to provide desired viscosity and rheology.

### Example Formulations

### Example Formulation #1

### Vinyl Acrylic Emulsion Formulation with Natrosol 250 MR (Hydroxyethyl Cellulose Thickener)

| | LAB |
|---|---|
| | CHARGE |
| MONOMER EMULSION CHARGE | |
| DI WATER | 345.5 |
| ABEX 18S (30%) | 18.5 |
| ETHAL CSA-20 (100%) | 5.4 |
| 48% N-METHYLOLACRYLAMIDE | 47.0 |
| SODIUM VINYLSULFONATE (25%) | 14.1 |
| TRIALLYL CYANURATE | 10.5 |
| BUTYL ACRYLATE | 64.2 |
| VINYL ACETATE | 527.0 |
| 50% ACRYLAMIDE | 22.5 |
| TOTAL | 1054.8 |
| REACTOR CHARGE | |
| DI WATER | 618.2 |
| ABEX 18S (30%) | 2.1 |
| ETHAL CSA-20 (100%) | 4.1 |
| 20% AMMONIA | 0.5 |
| TOTAL | 624.8 |
| INITIAL MONOMER | |
| VINYL ACETATE | 66.1 |
| TOTAL | 66.1 |
| PRIMARY INITIATOR (OXIDANT) | |
| DI WATER | 23.5 |
| SODIUM PERSULFATE | 1.3 |
| 20% AMMONIA | 0.5 |
| TOTAL | 25.3 |
| DELAYED INITIATOR (OXIDANT) | |
| DI WATER | 154.2 |
| SODIUM PERSULFATE | 1.5 |
| 20% AMMONIA | 3.9 |
| TOTAL | 159.6 |
| NATROSOL ADD | |
| DI WATER | 20.0 |
| NATROSOL 250 MR (100%) | 14.1 |
| TOTAL | 34.1 |
| FINISHING CATALYST | |
| 1.0% FERROUS SULFATE | 0.8 |
| FINISHING INITIATOR (OXIDANT) | |
| DI WATER | 12.5 |
| T-BUTYL HYDOPEROXIDE-70 | 1.3 |
| 20% AMMONIA | 0.5 |
| TOTAL | 14.2 |
| FINISHING INITIATOR (REDUCTANT) | |
| DI WATER | 17.4 |
| SODIUMFORMALDEHYDE SULFOXYLATE | 0.5 |
| 20% AMMONIA | 0.5 |
| TOTAL | 18.4 |
| POST ADD #1 | |
| DI WATER | 1.4 |
| 20% AMMONIA | 0.5 |
| KATHON LX | 0.1 |
| TOTAL | 1.9 |
| BATCH TOTAL | 2000.0 |
| TOTAL SOLIDS | 739.2 |
| THEO. % SOLIDS | 37.0% |

REACTION PROCEDURE:

| | |
|---|---|
| 1 | Add Reactor Charges to Reactor, stir and sparge with nitrogen, |
| | heat to 70 C.. |
| 2. | Add Abex 18S, Ethal CSA-20, and Sodium Vinyl Sulfonate to |
| | Monomer Emulsion Vessel and mix for 10 minutes. |
| 3. | Add all remaining monomers to Monomer Emulsion Vessel and mix |
| | at high speed. (Delayed Monomer) |
| 4. | Prepare Primary and Delay Initiator Solutions. |
| 5. | When Reactor temperature reaches 70 C., add Initial Monomer |
| | (Vinyl Acetate), and Primary Initiator, and allow exotherm to peak. |
| 6. | Begin Monomer and Initiator Delays over 210 minutes at 75 C.. |
| 7. | Maintain Reaction temperature at 79 C. during the delays. |
| 8. | 90 minutes before delays are completed, quickly sift in Natrosol |
| | 250 MR Post Add as a powder, followed with DI Water rinse. |
| 9. | After the delays are completed, hold reactor temperature at 79 C. for |
| | 15 minutes. |
| 10. | After 15 minute hold, cool batch to 60 C.. |
| 11. | Add Ferrous Sulfate finishing catalyst Solution, then add Finishing |
| | Initiator (oxidant) Solution, followed by Finishing Initiator |
| | (reductant) Solution and hold 15 minutes at 60 C.. |
| 12. | Cool Batch to 35 C. and make Post Add Additions. |
| 13. | Filter through a 200 mesh screen. |

Adding the Natrosol 250 MR thickener to the reactor 120 minutes into the monomer emulsion delays provides some distinct advantages:
Initiating the emulsion with vinyl acetate monomer and surfactant, with no Natrosol 250 MR present in the reactor charge, resulted in a small particle size seed, allowing for regular emulsion polymerization kinetics to proceed. When the Natrosol 250 MR was added later during the delays, the finished emulsion polymer had a mean particle size in the range of 150-350 nanometers (nm).

### Example Formulation #2

### Vinyl Acrylic Emulsion Formulation with KA-114 (Sodium Polyacrylate Thickener)

| | LAB |
|---|---|
| | CHARGE |
| MONOMER EMULSION CHARGE | |
| DI WATER | 343.3 |
| ABEX 18S (30%) | 18.4 |
| ETHAL CSA-20 (100%) | 5.4 |
| 48% N-METHYLOLACRYLAMIDE | 46.7 |
| SODIUM VINYLSULFONATE (25%) | 13.1 |
| TRIALLYL CYANURATE | 10.5 |
| BUTYL ACRYLATE | 63.7 |
| VINYL ACETATE | 523.7 |
| 50% ACRYLAMIDE | 22.9 |
| TOTAL | 1047.7 |
| REACTOR CHARGE | |
| DI WATER | 563.7 |
| ABEX 18S (30%) | 2.1 |
| ETHAL CSA-20 (100%) | 4.1 |
| TOTAL | 570.3 |
| INITIAL MONOMER | |
| VINYL ACETATE | 65.7 |
| TOTAL | 65.7 |
| PRIMARY INITIATOR (OXIDANT) | |
| DI WATER | 23.4 |
| SODIUM PERSULFATE | 1.3 |
| 20% AMMONIA | 0.5 |
| TOTAL | 25.1 |
| DELAYED INITIATOR (OXIDANT) | |
| DI WATER | 153.2 |
| SODIUM PERSULFATE | 1.5 |
| 20% AMMONIA | 3.9 |
| TOTAL | 158.6 |
| PRE-HEATED KA-114 THICKENER ADD | |
| DI WATER | 48.8 |
| KA-114 THICKENER (18%) | 48.8 |
| TOTAL | 97.6 |
| FINISHING CATALYST | |
| 1.0% FERROUS SULFATE | 0.8 |
| FINISHING INITIATOR (OXIDANT) | |
| DI WATER | 12.4 |
| T-BUTYL HYDOPEROXIDE-70 | 1.3 |
| 20% AMMONIA | 0.5 |
| TOTAL | 14.1 |
| FINISHING INITIATOR (REDUCTANT) | |
| DI WATER | 17.3 |
| SODIUMFORMALDEHYDE SULFOXYLATE | 0.5 |
| 20% AMMONIA | 0.5 |
| TOTAL | 18.2 |
| POST ADD #1 | |
| DI WATER | 1.4 |
| 20% AMMONIA | 0.5 |
| KATHON LX | 0.1 |
| TOTAL | 1.9 |
| BATCH TOTAL | 2000.0 |
| TOTAL SOLIDS | 729.3 |
| THEO. % SOLIDS | 36.5% |

REACTION PROCEDURE:

| | |
|---|---|
| 1. | Add Reactor Charges to Reactor, and heat to 70 C.. |
| 2. | Add Abex 18S, Ethal CSA-20, and Sodium Vinyl |
| | Sulfonate to Monomer Emulsion Vessel and mix for 10 minutes. |
| 3. | Add all remaining monomers to Monomer Emulsion Vessel and mix |
| | well. (Delayed Monomer) |
| 4. | Prepare Primary and Delay Initiator Solutions. |
| 5. | When Reactor temperature reaches 70 C., add Initial Monomer |
| | (Vinyl Acetate), and Primary Initiator, and allow exotherm to peak. |
| 6. | Begin Monomer and Catalyst Delays over 210 minutes at 75 C.. |
| 7. | Maintain Reaction temperature at 79 C. during the delays. |
| 8. | Preheat KA-114 Thickener and DI Water mixture to 55-70 C.. |
| 9. | 90 minutes before delays are completed, add preheated mixture of |
| | KA-114 Thickener and DI Water Post Add to Reactor. |
| 10. | After the delays are completed, hold reactor temperature at 79 C. for |
| | 15 minutes. |
| 11. | After 15 minute hold, cool batch to 65 C.. |
| 12. | Add Ferrous Sulfate finishing catalyst Solution; then add Finishing |
| | Initiator (oxidant) Solution, followed by Finishing Initiator |
| | (reductant) Solution and hold 15 minutes at 60 C.. |
| 13. | Cool Batch to 35 C. and make Post Add Additions. |
| 14. | Filter through a 200 mesh screen. |

Adding the KA-114 thickener to the reactor 120 minutes into the monomer emulsion delays provides some distinct advantages.
Initiating the emulsion with vinyl acetate monomer and surfactant, with no KA-114 present in the reactor charge, resulted in a small particle size seed, allowing for regular emulsion polymerization kinetics to proceed. When the KA-114 was added later during the delays, the finished emulsion polymer had a mean particle size in the range of 150-350 nanometers.

The table below shows physical properties Formulation #1 and Formulation #2 versus the OMNOVA DW-1 vinyl acetate latex, for Carver Press heat resistance, Sentinel Press heat resistance, and % weight gain in toluene.

| | Carver Press: | Heat Sentinel: | % Weight Gain |
|---|---|---|---|
| | 250° F. | 350° F. | in Toluene |
| Product | for 30 seconds | for 30 seconds | after 24 hours |
| Formulation #1 | 0 | 1 | 195 |
| Formulation #2 | 1 | 2 | 175 |
| DW-1 latex | ˜5 | ˜5 | ˜700 |

Carver Press and Heat Sentinel
1 Excellent heat resistance
5 very poor heat resistance

### Example Formulation #3

| | LAB |
|---|---|
| | CHARGE |
| MONOMER EMULSION CHARGE | |
| DI WATER | 342 |
| ABEX 18S (30%) | 18.4 |
| ETHAL CSA-20 (100%) | 5.4 |
| 48% N-METHYLOLACRYLAMIDE | 47 |
| SODIUM VINYLSULFONATE (25%) | 13.1 |
| TRIALLYL CYANURATE | 10.5 |
| BUTYL ACRYLATE | 63.7 |
| VINYL ACETATE | 522 |
| 50% ACRYLAMIDE | 23 |
| TOTAL | 1045 |
| REACTOR CHARGE | |
| DI WATER | 525 |
| ABEX 18S (30%) | 2.1 |
| ETHAL CSA-20 (100%) | 4.1 |
| TOTAL | 532 |
| INITIAL MONOMER | |
| VINYL ACETATE | 65.7 |
| TOTAL | 65.7 |
| PRIMARY INITIATOR (OXIDANT) | |
| DI WATER | 23.4 |
| SODIUM PERSULFATE | 1.3 |
| 20% AMMONIA | 1 |
| TOTAL | 25.1 |
| DELAYED INITIATOR (OXIDANT) | |
| DI WATER | 153.2 |
| SODIUM PERSULFATE | 1.5 |
| 20% AMMONIA | 4 |
| TOTAL | 158.6 |
| PRE-HEATED KA-2000 THICKENER ADD | |
| DI WATER | 70 |
| KA-2000 THICKENER (15%) | 70 |
| TOTAL | 140 |
| FINISHING CATALYST | |
| 1.0% FERROUS SULFATE | 1 |
| FINISHING INITIATOR (OXIDANT) | |
| DI WATER | 12.4 |
| T-BUTYL HYDOPEROXIDE-70 | 1.3 |
| 20% AMMONIA | 1 |
| TOTAL | 14.1 |
| FINISHING INITIATOR (REDUCTANT) | |
| DI WATER | 17.3 |
| SODIUMFORMALDEHYDE SULFOXYLATE | 1 |
| 20% AMMONIA | 1 |
| TOTAL | 19 |
| POST ADD #1 | |
| DI WATER | 1.4 |
| 20% AMMONIA | 1 |
| KATHON LX | 0.1 |
| TOTAL | 2 |
| BATCH TOTAL | 2000.0 |
| TOTAL SOLIDS | 729.3 |
| THEO. % SOLIDS | 36.5% |

REACTION PROCEDURE:

| | |
|---|---|
| 1. | Add Reactor Charges to Reactor, and heat to 70 C.. |
| 2. | Add DI Water, Abex 18S, Ethal CSA-20, and Sodium Vinyl |
| | Sulfonate to Monomer Emulsion Vessel and mix for 10 minutes. |
| 3. | Add all remaining monomers to Monomer Emulsion Vessel and mix |
| | under high shear agitation. (Delayed Monomer) |
| 4. | Prepare Primary and Delay Catalyst Solutions. |
| 5. | When Reactor temperature reaches 70 C., add Initial Monomer |
| | (Vinyl Acetate), and Initial Catalyst, and allow exotherm to peak. |
| 6. | Begin Monomer and Catalyst Delays over 210 minutes at 75 C.. |
| 7. | Maintain Reaction temperature at 79 C. during the delays. |
| 8. | Preheat KA-2000 Thickener and DI Water mixture to 55-70 C.. |
| 9. | 90 minutes before delays are completed, add preheated mixture of |
| | KA-2000 Thickener and DI Water Post Add to Reactor. |
| 10. | After the delays are completed, hold reactor temperature at 79 C |
| | for 15 minutes. |
| 11. | After 15 minute hold, cool batch to 65 C.. |
| 12. | Add Ferrous Sulfate finishing catalyst Solution, then add Finishing |
| | Initiator (oxidant) Solution, followed by Finishing Initiator |
| | (reductant) Solution and hold 15 minutes at 60 C.. |
| 13. | Cool Batch to 35 C. and make Post Add Additions. |
| 14. | Filter through a 200 mesh screen. |

Test Procedure for Carver Press Test for Blocking
Make sure glass plate and Meyer rod is completely clean. Set forced air oven temperature to 275° F. (135° C.).
1. Tape the corners of pre-cut control paper to top of clipboard under clasp, making sure the length of sheet is in the machine direction.
2. With a pipette, apply a generous amount of film forming polymer emulsion about 1 inch (2.54 cm) from edge of the sheet across the width direction.
3. Immediately draw the bead of film forming polymer emulsion down the sheet for an even coating across the entire sheet.
4. Immediately remove the sheet from the glass plate and hang on door of forced air oven for one minute.
5. Remove cured sheet from oven and take to cutting table at front of lab and cut out 3 inch by 5-inch (12.7 cm) sample strips using a die- cutter in the length direction.
6. Fold each of the 1.25 inch (3.18 cm) by 11 inch (27.9 cm) strips in half with the release coated side on the inner side of the fold.
7. Place each folded strip in the Carver Press Machine (one-by-one) with the open-end hanging out 1-1.5 inches (2.54-3.81 cm).
8. With the Carver Press set at 250° F. (121° C.), close the press to 5000 lbs. (2268 kg) of pressure for 30 seconds, then release.

9. Allow to cool and peel the sample the sample apart by hand and rate:

| | |
|---|---|
| B | for Blocked |
| VS | for very Sticky |
| S | for Sticky |
| SS | for Slightly Sticky |
| C | for Cured |

Test Procedure for Heat Sentinel
Make sure glass plate and Meyer rod is completely clean. Set forced air oven temperature to 275° F. (135° C.).
1. Tape the corners of pre-cut control paper to top of clipboard under clasp, making sure the length of sheet is in the machine direction.
2. With a pipette, apply a generous amount of film forming polymer emulsion about 1 inch (2.54 cm) from edge of the sheet across the width direction.
3. Immediately draw the bead of emulsion down the sheet for an even coating across the entire sheet.
4. Immediately remove the sheet from the glass plate and hang on door of forced air oven for one minute.
5. Remove the cured sheet from the oven door. Using the die cutter cut 1¼ inch (3.18 cm) by 11 inch (27.9 cm) strips to produce 3 to 5 samples, then cut these samples in half.
6. Fold each of the samples with the release coated side on the inner side of the fold (coated to coated).
7. Turn on the air supply line to the Sentinel Heat Seal Instrument and set the pressure gage to 80 psi (5.5×10⁵ Pa). Set the temperature for the top and bottom clamps at 350° F. (177° C.). Set the timer for 30 seconds.
8. Insert the 3 to 5 folded strips into the clamps. Press the foot pedal down and hold. This engages the clamps under heat and pressure upon the folded strips. After 30 seconds, the foot pedal will automatically release. Remove the strips and allow them to cool to room temperature.

9. Peel the strips apart by hand and rate:

| | |
|---|---|
| B | for Blocked |
| VS | for very Sticky |
| S | for Sticky |
| SS | for Slightly Sticky |
| C | for Cured |

Toluene Swell Test Procedure
1. Pour 10 dry grams (approximately 28.6 wet grams) of latex into a 9.2 cm Teflon cup.
2. Air dry latex in Teflon cup at room temperature (25C) for 7 days.
3. Pry out and remove film from the Teflon cup.
4. Place the film in a 275F (135C) forced air oven for 10 minutes to cure.
5. Remove film, and while still warm, cut a 3-inch (7.62 cm) by 1-inch (2.54 cm) strip from the center of the film.
6. Weigh a filmstrip to the fourth decimal place using an analytical balance.
7. Place the filmstrip in a closed 4-oz jar of toluene at room temperature.
8. Continue to soak the filmstrip in toluene at room temperature for 24 hours.
9. After the 24 hour soaking period remove the filmstrip, pad dry with a paper towel, then re-weigh on the analytical balance.
10.

$$\% toluene swell = \frac{film strip weight after soaking}{film strip weight prior to soaking} \times 100$$

1. A backsize composition comprising
pre-crosslinked film forming polymer derived from materials comprising
monofunctional monomer and
multifunctional pre-crosslinking monomer containing at least two reactive groups,
thickener to stabilize the backsize composition, and
release agent.

2. The composition of claim 1 wherein the composition is an aqueous backsize composition that is stable for more than a week when stored at 25C.

3. The composition of claim 2 comprising from 0.1 to 3 weight percent thickener based on the total weight of solids.

4. The composition of claim 2 wherein the thickener is selected from the group consisting of a cellulosic thickener, a polyacrylate thickener, and mixtures thereof.

5. The composition of claim 2 wherein the thickener is selected from the group consisting of hydroxyethylcellulose and sodium polyacrylate.

6. The composition of claim 1 wherein the dried composition exhibits less than a 250 percent weight gain in toluene after 24 hours.

7. The composition of claim 1 wherein the film forming polymer comprises monomeric units derived from 0.5 to 5 weight percent multifunctional monomer based on total weight of monomer.

8. The composition of claim 1 wherein
monofunctional monomer is selected from the group consisting of vinyl acetate, butyl acrylate, and a combination thereof, and
thickener is selected from the group consisting of a cellulosic thickener, a polyacrylate thickener, and mixtures thereof.

9. The composition of claim 1 comprising release agent comprising a polysiloxane block copolymer.

10. The composition of claim 1 wherein the composition is an aqueous backsize composition comprising
50 to 94.5 weight percent film forming polymer comprising monomeric units derived from monomers comprising vinyl acetate and butyl acrylate,
5 to 60 weight percent release agent, and
0.1 to 3 weight percent thickener selected from the group consisting of a cellulosic thickener, a polyacrylate thickener, and mixtures thereof, based on the weight of total solids.

11. An aqueous backsize composition comprising
pre-crosslinked film forming polymer derived from materials comprising
monofunctional monomer and
multifunctional pre-crosslinking monomer containing at least two reactive groups,
thickener selected from the group consisting of a polyacrylate thickener, a cellulosic thickener, and mixtures thereof, and
release agent.

12. The composition of claim 11 comprising thickener selected from the group consisting of hydroxyethylcellulose and sodium polyacrylate.

13. A method of preparing film forming polymer, the method comprising
providing monomer comprising monofunctional monomer and multifunctional pre-crosslinking monomer containing at least two reactive groups,
subjecting a portion of the monomer to polymerization,
adding thickener after polymerization of a portion of monomer, and
polymerizing a further portion of monomer following addition of the thickener.

14. The method of claim 13 wherein the thickener is selected from the group consisting of a cellulosic, a polyacrylate, and mixtures thereof.

15. The method of claim 13 wherein thickener is added at a time between about ⅓ to about ⅔ of the total time of polymerization.

16. The method of claim 15 wherein the polymerization reaction occurs with addition of monomer over a period in the range from about 150 minutes and about 250 minutes, and thickener is added at a time after about to 90 minutes of that period.

17. The method of claim 15 wherein the polymerized film forming polymer is stable for more than a week when stored at 25C.

18. The method of claim 15 further comprising combining the film forming polymer with release agent to form a low adhesion backsize composition.

19. The method of claim 18 wherein the low adhesion backsize composition is stable for more than a week when stored at 25C.

20. A method of forming a release coating, the method comprising
providing a backsize composition comprising
pre-crosslinked film forming polymer comprising monomeric units derived from monomer comprising
monofunctional monomer and
multifunctional pre-crosslinking monomer containing at least two reactive groups,
thickener that improves the stability of the backsize composition, and
release agent,
coating the backsize composition onto a substrate to form a backsize film, and
drying the film to form a dried release coating.
